(19) United States
(12) Patent Application Publication
(10) Pub. No.: US 2024/0217374 A1
(43) Pub. Date: Jul. 4, 2024

(54) DECENTRALIZED IDENTITY-BASED AUTHENTICATION METHOD AND APPARATUS FOR AN ELECTRIC VEHICLE CHARGING SERVICE

(71) Applicant: HYUNDAI AUTOEVER CORP., Seoul (KR)

(72) Inventor: Ki Ho Yeo, Seoul (KR)

(73) Assignee: HYUNDAI AUTOEVER CORP., Seoul (KR)

(21) Appl. No.: 18/400,207

(22) Filed: Dec. 29, 2023

(30) Foreign Application Priority Data
Dec. 30, 2022 (KR) 10-2022-0190857

(51) Int. Cl. B60L 53/65; B60L 53/67; B60L 53/68

(52) U.S. Cl. CPC B60L 53/65; B60L 53/67; B60L 53/68

(57) ABSTRACT

A decentralized identity (DID)-based Plug and Charge (PnC) authentication method may comprise: transmitting, by an electric vehicle (EV), a first DID possessed by the EV to an electric vehicle supply equipment (EVSE); transmitting, by the EVSE, a second DID possessed by the EVSE to the EV; receiving, by the EV, a second DID document required for verification of the second DID; receiving, by the EVSE, a first DID document required for verification of the first DID; and mutually-authenticating, by the EV and the EVSE, the first DID and the second DID with each other.

### CROSS-REFERENCE TO RELATED APPLICATIONS

This application claims priority to Korean Patent Application No. 10-2022-0190857, filed on Dec. 30, 2022, with the Korean Intellectual Property Office (KIPO), the entire contents of which are hereby incorporated by reference.

### BACKGROUND

### 1. Technical Field

The present disclosure relates to a technique for installing and managing a certificate for electric vehicle (EV) charging, and more specifically, to an identify-based authentication technique that improves convenience.

### 2. Related Art

The contents described in this part merely provide background information on embodiments of the present disclosure and do not constitute prior arts.

In general, among electric vehicle (EV) charging schemes, a Plug and Charge (PnC) scheme is to perform EV charging and payment therefor according to a pre-contract. The PnC scheme may improve user convenience as compared to an External Identification Means (EIM) scheme necessarily requiring external user interfaces. In order to pay a charging fee in the PnC scheme, a pre-contract with a power supplier should be made, and an EV charging certificate that certifies details of the contract should be installed in the EV. In addition, the aforementioned EV charging certificate may be issued from a power supplier server of a power supplier through a charging device in a state in which the EV and the charging device are connected.

Meanwhile, when installing or updating the EV charging certificate, the EV should be connected to the charging device even if the EV is not being charged, which causes a lot of inconvenience to a user of the EV in the process of installing and managing the EV charging certificate.

In addition, when different power suppliers in different regions provide PnC charging services, the EV user should make pre-contracts with all different power suppliers. Since it is not possible to set a specific EV charging certificate as a default when a plurality of EV charging certificates is installed in one EV, there is a problem that the EV user experiences inconveniences when charging the EV in different regions. In other words, the EV user has no choice but to use the PnC charging service only in a specific region and use the EIM charging service in other regions.

As part of an attempt to solve such the inconvenience, Korean patent publication No. KR 10-2021-0083717 titled as ‘installation management system and method for EV charging certificate’ has been disclosed. The prior art document proposed a technique capable of installing or updating an EV charging certificate without having to connect an EV to a charging device.

However, even according to the above prior literature, there may be various unsolved problems. One such problem is of no guarantee of trust between multiple players performing different functions participating in the EV charging service. Another problem is of compatibility issues when adding operators. Yet another problem is of a fraudulent act in which identification information stored in the EV is leaked in the process of identifying and authenticating the EV, and a malicious EV disguised as the normal EV using the leaked identification information makes a charging fee be imposed on the normal EV. Still another problem is when the malicious EV does not pay the charging fee.

### SUMMARY

The present disclosure has been derived to solve the problems of the prior arts and aims to provide high reliability by verifying an identity using decentralized/distributed ledger techniques having strong anti-counterfeiting characteristics.

An objective of the present disclosure is to improve compatibility by handling various types of identity proofs using decentralized identity (DID).

An objective of the present disclosure is to propose a DID-based authentication scheme that can enhance independence and reliability of each business operator despite a vertical relationship according to a supply chain of multiple players participating in an EV charging service.

A DID-based PnC authentication method, according to an embodiment of the present disclosure for achieving the above objective, may comprise transmitting, by an electric vehicle (EV), a first DID possessed by the EV to an electric vehicle supply equipment (EVSE) and transmitting, by the EVSE, a second DID possessed by the EVSE to the EV. The method may also comprise receiving, by the EV, a second DID document required for verification of the second DID and receiving, by the EVSE, a first DID document required for verification of the first DID. The method may also comprise mutually-authenticating, by the EV and the EVSE, the first DID and the second DID with each other.

The DID-based PnC authentication method may further comprise requesting, by the EV, verification of the second DID to an original equipment manufacturer (OEM) server. In receiving the second DID document, the EV receives the second DID document from the OEM server.

The DID-based PnC authentication method may further comprise receiving, by the OEM server, the second DID document from a verifiable data registry.

The DID-based PnC authentication method may further comprise transmitting, by a resolver module of the OEM server, a search request for the second DID document stored in the verifiable data registry to the verifiable data registry.

The DID-based PnC authentication method may further comprise requesting, by the EVSE, verification of the first DID to a charging station operator (CSO) server, wherein in the receiving of the first DID document, the EVSE receives the first DID document from the CSO server.

The DID-based PnC authentication method may further comprise receiving, by the CSO server, the first DID document from a verifiable data registry.

The mutually-authenticating may comprise authenticating, by the EV, the verified second DID and authenticating, by the EVSE, the verified first DID.

The DID-based PnC authentication method may further comprise receiving, by the EV, electric power from the EVSE.

The DID-based PnC authentication method may further comprise receiving, by the EV, electric power from a second EVSE adjacent to the EV, the second EVSE being an EVSE other than the EVSE that has mutually authenticated the first DID and the second DID.

The DID-based PnC authentication method may further comprise receiving, by the second EVSE, a result of mutually authenticating the first DID and the second DID from the EVSE.

The DID-based PnC authentication method may further comprise transmitting, by the EV, the first DID possessed by the EV to an entity belonging to an intelligent transportation system: receiving, by the EV, a third DID from the entity: and mutually-authenticating, by the EV and the entity, the first DID and the third DID with each other.

The DID-based PnC authentication method may further comprise generating, by the EV, the first DID in response to a first DID generation request of a user and generating, by the EV, the first DID document corresponding to the first DID. The method may further comprise requesting, by the EV, an OEM server to register the first DID document and transmitting, by the OEM server, the first DID document to a verifiable data registry for registration.

The DID-based PnC authentication method may further comprise: requesting, by the EV, an OEM server to issue a vehicle proof: issuing and transmitting, by the OEM server, the vehicle proof to the EV: submitting, by the EV, the vehicle proof to the EVSE: and requesting, by the EVSE, a CSO server to verify the vehicle proof.

The DID-based PnC authentication method may further comprise transmitting, by the EV, a service subscription request of a user to an OEM server and transmitting, by the OEM server, the service subscription request to an e-mobility service provider (EMSP) server. The method may further comprise generating, by the EMSP server, an e-mobility account identifier (EMAID) and transmitting, by the EMSP server, the EMAID to the EV via the OEM server. The method may further comprise: requesting, by the user, issuance of a contract proof to the EV: transmitting, by the EV, a vehicle proof to the EMSP server via the OEM server in response to the request for issuance of the contract proof; and issuing, by the EMSP server, the contract proof.

A DID-based PnC authentication apparatus, according to an embodiment of the present disclosure for achieving the above objective, may comprise a memory storing at least one instruction and a processor executing the at least one instruction. The processor may execute the at least one instruction to: execute an electronic wallet application that stores and manages DIDs: transmit a first DID stored in the electronic wallet application to an electric vehicle supply equipment (EVSE): receive a second DID possessed by the EVSE; receive a second DID document required for verification of the second DID; and mutually-authenticate the first DID and the second DID with the EVSE.

The processor and the memory may be mounted on an electric vehicle (EV).

The processor may further execute the at least one instruction to request an original equipment manufacturer (OEM) server to verify the second DID and to receive the second DID document from the OEM server.

The processor may further execute the at least one instruction to, when a mutually-authenticating with the EVSE for the first DID and the second DID is completed, control the EV to receive electric power from the EVSE.

The processor may further execute the at least one instruction to, when a mutually-authenticating with the EVSE for the first DID and the second DID is completed, control the EV to receive electric power from a second EVSE adjacent to the EV. The second EVSE may be an EVSE other than the EVSE that has mutually authenticated the first DID and the second DID.

The processor may further execute the at least one instruction to: control the electronic wallet application to generate the first DID in response to a first DID generation request of a user; control the electronic wallet application to generate a first DID document corresponding to the first DID: and request the OEM sever to register the first DID document.

According to an embodiment of the present disclosure, identity can be verified using decentralized/distributed ledger technology having strong forgery prevention characteristics, thereby increasing reliability.

According to an embodiment of the present disclosure, various types of identity proofs can be handled using decentralized identity (DID), and thus compatibility can be increased.

According to an embodiment of the present disclosure, it is made possible to implement a DID-based authentication technique that can increase the independence and reliability of each business operator despite a vertical relationship according to a supply chain of a plurality of players participating in an EV charging service.

### BRIEF DESCRIPTION OF DRAWINGS

FIG. 1 is a conceptual diagram illustrating a mutual identification and authentication process between an electric vehicle (EV) and an electric vehicle supply equipment (EVSE) in a decentralized identity (DID)-based Plug and Charge (PnC) authentication method according to an embodiment of the present disclosure.

FIG. 2 is a conceptual diagram illustrating an internal system configuration of an EV for a DID-based PnC authentication method according to an embodiment of the present disclosure.

FIG. 3 is a conceptual diagram illustrating a process of generating a DID of an EV for a DID-based PC authentication method according to an embodiment of the present disclosure.

FIG. 4 is a conceptual diagram illustrating a process of issuing and submitting a vehicle certificate of an EV for a DID-based PnC authentication method according to an embodiment of the present disclosure.

FIG. 5 is a conceptual diagram illustrating a format of a vehicle identification number (VIN), which is a unique identification number of a vehicle, for a DID-based PnC authentication method according to an embodiment of the present disclosure.

FIG. 6 is a conceptual diagram illustrating a service subscription process and a contract proof issuance/storage process of an EV for a DID-based PnC authentication method according to an embodiment of the present disclosure.

FIG. 7 is a conceptual diagram illustrating a use case scenario that provides scalability according to an increase in participants in a DID-based PnC authentication process according to an embodiment of the present disclosure.

FIG. 8 is a conceptual diagram illustrating a use case scenario in which connectivity between different regions/countries/continents is provided in a DID-based PnC authentication process according to an embodiment of the present disclosure.

FIG. 9 is a conceptual diagram illustrating an example of a generalized DID-based PnC authentication apparatus, a controller of an EV, or a computing system capable of performing at least part of the processes of FIGS. 1-8.

### DETAILED DESCRIPTION OF THE EMBODIMENTS

Since the present disclosure may be variously modified and have several forms, specific embodiments are shown in the accompanying drawings and are described in detail in the detailed description. It should be understood, however, that it is not intended to limit the present disclosure to the specific embodiments but to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named as a second component without departing from the scope of the present disclosure, and the second component may also be similarly named as the first component. The term “and/or” means any one or a combination of a plurality of related and described items.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it should be understood that a further component is not disposed therebetween.

The terms used in the present disclosure are only used to describe specific embodiments and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists. However, it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Meanwhile, even if a technology is known prior to the filing date of the present disclosure, the technology may be included as part of the configuration of the present disclosure when necessary, and the technology is described herein without obscuring the spirit of the present disclosure. However, in describing the configuration of the present disclosure, a detailed description on matters that can be clearly understood by those having ordinary skill in the art as a known technology prior to the filing date of the present disclosure may obscure the purpose of the present disclosure, so an excessively detailed description on the known technology has been omitted. When a component, device, element, or the like of the present disclosure is described as having a purpose or performing an operation, function, or the like, the component, device, or element should be considered herein as being “configured to” meet that purpose or to perform that operation or function and may separately embody or be included with a processor and a memory, such as a non-transitory computer readable media, as part of the apparatus.

For example, known technologies prior to the filing of the present disclosure may be used as an authentication technology for Plug and Charge (PnC) using centralized authentication, distributed/decentralized ledger implementation technology for decentralization such as blockchain, and the like, and at least some of these known technologies may be applied as elemental technologies required for practicing the present disclosure.

However, the contents of the known technologies may be included as part of the present disclosure within the scope not departing from the spirit of the present disclosure.

In the present disclosure, an electric vehicle (EV) refers to an electric vehicle (e.g., PHEV/BEV) operated by receiving electricity through a charging infrastructure. A vehicle (e.g., HEV) driven with an internal combustion engine and charged while driving may be included in the EV of the present disclosure within a range that meets the purpose of the present disclosure.

An electric vehicle communication controller (EVCC) refers to an in-vehicle system that communicates with a supply equipment communication controller (SECC). The EVCC may perform controls on input and output channels, data encryption, or data transmission between the EV and the SECC as its main functions.

There are several entities between the EV and the charging infrastructure, which are divided into primary actors, who are directly involved in a charging process, and secondary actors, who are indirectly involved in the charging process.

The EV and the EVCC may be classified as the primary actors.

An electric vehicle supply equipment (EVSE) refers to an EV power supply device, which means a charging facility that delivers power to the EV directly through a plug, and the EVSE communicates with the EV as needed. A synonym for the EVSE may be a charging point (CP). A charging station (CS) may have one or more EVSEs.

A supply equipment communication controller (SECC) may refer to a power supply device communication controller. The SECC may be an entity that communicates with one or multiple EVCCs and interacts with the secondary actors. The main functions of the SECC may include controls on input and output channels, data encryption, or data transmission with the EVCC.

An EV user refers to an individual or a corporation that uses the EV and provides information on driving needs to affect a charging pattern.

A user interface (human machine interface, HMI) refers to an interface through which a driver can receive various information and deliver inputs.

Descriptions on the secondary actors may be as follows.

A vehicle manufacturer (original equipment manufacturer, OEM) generally refers to a manufacturer that manufactures products or parts sold under a trademark of a purchasing company, but in the present disclosure, it may refer to a manufacturer that produces the EV as an original equipment manufacturer.

A charging station operator (CSO) has the same meaning as a charging point operator (CPO) and refers to an operator responsible for installing and operating charging stations and managing electricity to provide charging services as an electric vehicle power supply operator.

An e-mobility service provider (e-mobility service provider, EMSP) has the same meaning as a mobility operator (MO) and refers to a type of a mobility operator responsible for services such as authentication and payment as a charging service provider that holds contracts for all services related to driver's EV operations. The OEM or power supplier may also play roles of the mobility service provider as an EMSP or MO.

A certificate provisioning service (CPS) refers to a service that registers contract information and contract certificates created by the mobility service provider. The CPS safely and easily installs a new contract certificate in the EV through a signed message when a certificate installation request is received. It is assumed that it is mainly operated by the mobility service provider.

In addition, the following descriptions on various certificates are made.

An OEM provisioning certificate refers to a certificate issued to the EV to request and receive a contract certificate from the e-mobility service provider (EMSP). The OEM provisioning certificate is issued by an OEM public key infrastructure (PKI) certification authority (CA) and may usually be stored in a safe space within an electronic control unit (ECU) during a process of producing the EV.

An SECC certificate refers to a certificate issued for the SECC in a vehicle-to-grid (V2G) PKI system used within a transport layer security (TLS) so that the EVCC can authenticate the SECC.

A contract certificate refers to a certificate, which is issued by the EMSP, delivered to the EV to identify a contract, and required for the EV to sign information for charging and payment.

A certification ID (Cert ID) is a unique ID required to issue the OEM provisioning certificate. This information is required to be delivered to an owner of the EV at the time the EV is sold. It is specified as a 17-digit alpha-numeric string in the ISO 15118 annex F. It has the same role as a provisioning certificate ID (PCID) of the German VDE application guide.

An e-mobility account identifier (EMAID) is an EV service account identifier and is a unique ID required to issue a contract certificate as a charging service contract ID according to the ISO 15118-1 ED1. Its specification is described in the ISO 15118-2 annex H. It refers to an identifier linked to a service payment account, which identifies a single contract certificate issued under a legal agreement concluded between the EMSP and a customer for EV charging.

An EVSE ID refers to a unique identification ID of the EVSE.

Hereinafter, with reference to the accompanying drawings, embodiments of the present disclosure are described in more detail. In order to facilitate overall understanding in the description of the present disclosure, the same reference numerals are used for the same or equivalent components in the drawings, and redundant descriptions of the same components are omitted.

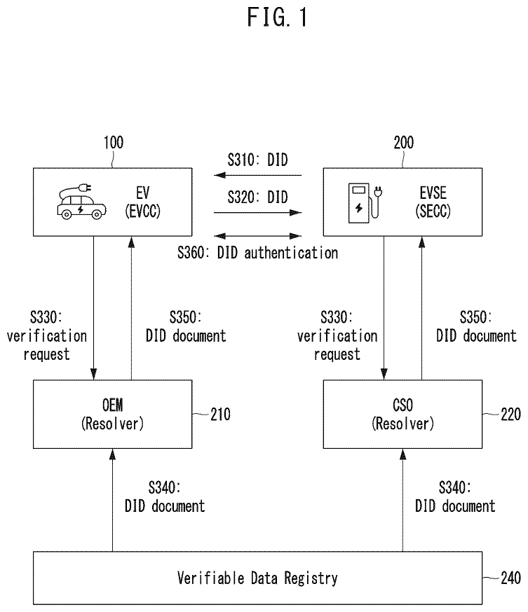

FIG. 1 is a conceptual diagram illustrating a mutual identification and authentication process between an EV and an EVSE in a DID-based PnC authentication method according to an embodiment of the present disclosure.

A DID-based PnC authentication method according to an embodiment of the present disclosure may comprise a step S320 of transmitting, by an EV 100, a first DID possessed by the EV 100 to an EVSE 200 and a step S310 of transmitting, by the EVSE 200, a second DID possessed by the EVSE 200 to the EV 100. The method may also comprise a step S350 of receiving, by the EV 100, a second DID document required for verification of the second DID and a step S350 of receiving, by the EVSE 200, a first DID document required for verification of the first DID. The method may also comprise a step S360 of mutually-authenticating, by the EV 100 and the EVSE 200, the first DID and the second DID.

In this case, the DID may be a random identifier generated for authentication and may be information separate from a proof.

The DID document may be distinguished from the DID, and as information required for authentication, the DID document may refer to information subordinate to the DID.

The DID-based PnC authentication method according to an embodiment of the present disclosure may further comprise a step S330 of requesting, by the EV 100, verification of the second DID to a vehicle manufacturer (OEM) server 210.

In the step S350 of receiving the second DID document by the EV 100 (S350), the EV 100 may receive the second DID document from the OEM server 210.

The DID-based PnC authentication method according to an embodiment of the present disclosure may further comprise a step S340 of receiving, by the OEM server 210, the second DID document from a verifiable data registry 240.

The DID-based PnC authentication method according to an embodiment of the present disclosure may further comprise a step of transmitting, by a resolver module of the OEM server 210 and to the verifiable data registry 240, a search request for the second DID document stored in the verifiable data registry 240.

The DID-based PnC authentication method according to an embodiment of the present disclosure may further comprise a step S330 of requesting, by the EVSE 200, verification of the first DID to a charging station operator (CSO) server 220.

In the step S350 of receiving the first DID document by the EVSE 200, the EVSE 200 may receive the first DID document from the CSO server 220.

The DID-based PnC authentication method according to an embodiment of the present disclosure may further comprise a step S340 of receiving, by the CSO server 220, the first DID document from the verifiable data registry 240.

The step S360 of mutually-authenticating may comprise: a step of authenticating, by the EV 100, the verified second DID: and a step of authenticating, by the EVSE 200, the verified first DID.

The DID-based PnC authentication method according to an embodiment of the present disclosure may further comprise a step of receiving, by the EV 100, power from the EVSE.

In the DID-based authentication model, a role that the OEM server 210 plays in mobility services related to EV charging may be expanded. The OEM may be required to function as a channel to communicate with the outside beyond a role of a manufacturer that simply produces the EV 100. As the paradigm of the automobile industry has recently changed, the OEM server 210 is also actively participating in mobility services and performing various roles.

In the DID-based authentication model according to an embodiment of the present disclosure, the OEM server 210 may serve as an intermediary between the EV 100 and the distributed ledger.

In the DID-based authentication model according to an embodiment of the present disclosure, when the EV 100 and the EVSE 200 are connected for the first time, the EV 100 and the EVSE 200 may exchange DIDs with each other as shown in FIG. 1 (S310, S320) and bring DID documents required for ownership authentication from the ledger (S330, S340, S350). Thereafter, a DID authentication (Auth) process (S360) of authenticating the DIDs identified by the EV 100 and the EVSE 200 may proceed. In this process, the OEM server 210 may serve as an intermediary for finding and bringing DID documents from the distributed ledger. This function may be called a resolver in a basic DID service model. Alternatively, the OEM server 210 may serve as a registrar for registering the DID documents.

In the DID-based authentication model according to an embodiment of the present disclosure, the OEM server 210 may serve as an intermediary between the EV 100 and the EMSP 230.

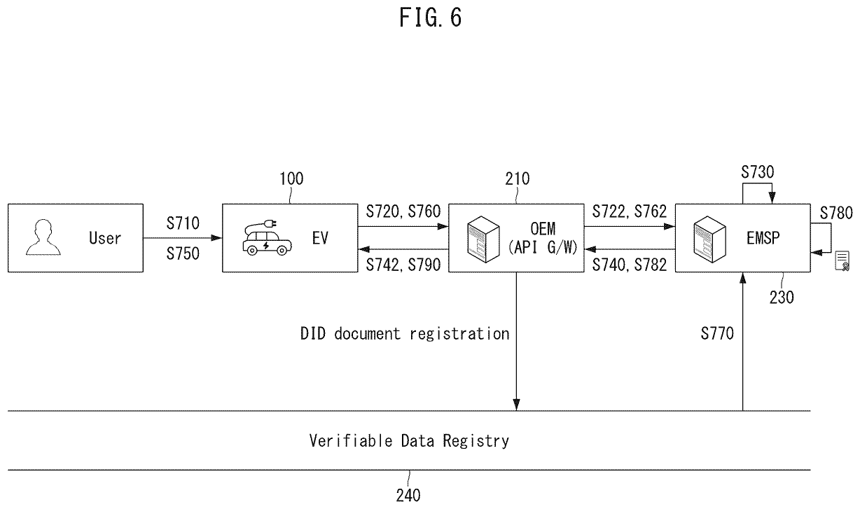

As shown in FIG. 6 to be described below, even when the EV 100 requests a contract certificate from the EMSP 230, the EV 100 may be connected to the EMSP 230 via the OEM server 210. In this case, it may be safe to determine the OEM server 210 as a first endpoint of the EV 100, which is capable of communicating with the outside.

In the DID-based authentication model according to an embodiment of the present disclosure, the OEM server 210 may serve as a DID system provider for EV charging.

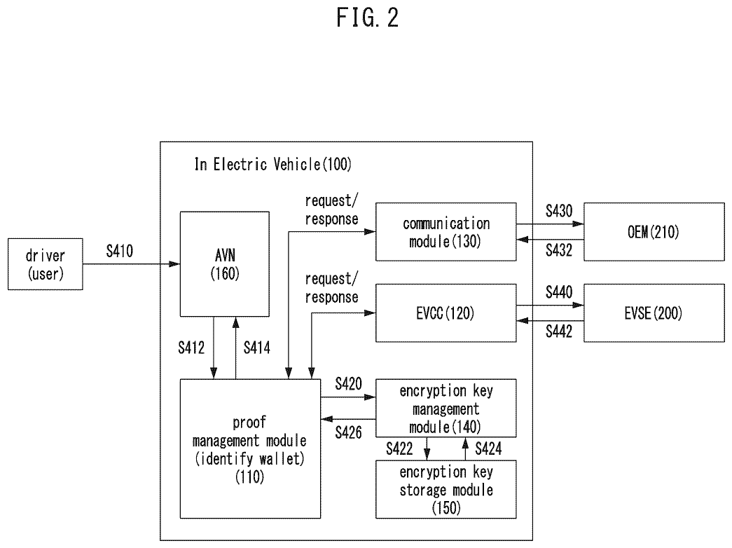

Meanwhile, even inside the EV 100, a part of the DID system may be implemented as shown in FIG. 2 below.

FIG. 2 is a conceptual diagram illustrating an internal system configuration of an EV for a DID-based PC authentication method according to an embodiment of the present disclosure.

In an embodiment of the present disclosure, in order for the EV 100 to become a holder of a DID, an electronic wallet/identity wallet 110 capable of safely storing certificates in the EV may be implemented.

In addition, a device capable of generating and managing a DID and a pair of a public key and a private key may be included in the EV 100.

In workflows S410 and S412, a DID generation request, a PIN code input, and a request for contract certificate issuance/reissuance/revocation may be transmitted from a driver to the electronic wallet 110 via an Audio, Video, Navigation (AVN) (or Audio, Video, Navigation, Telematics (AVNT)) module 160.

In a workflow S414, information may be provided from the electronic wallet 110 to the AVN module 160.

In a workflow S420, a key request may be transmitted from the electronic wallet 110 to an encryption key management module 140. In a workflow S422, information for storing an encryption key may be delivered from the encryption key management module 140 to an encryption key storage module 150. In a workflow S424, the encryption key stored in the encryption key storage module 150 may be provided to the encryption key management module 140. In a workflow S426, the encryption key may be provided from the encryption key management module 140 to the electronic wallet 110.

In a workflow S430, a DID document request may be delivered from the electronic wallet 110 to the OEM server 210 via a communication module 130. In a workflow S432, the DID document may be delivered from the OEM server 210 to the electronic wallet 110 via the communication module 130.

In a workflow S440, authentication/charging/payment requests may be delivered from the electronic wallet 110 or the EVCC 120 to the EVSE 200. In a workflow S442, authentication/charging/payment may be provided from the EVSE 200 to the electronic wallet 110 or the EVCC 120.

In an embodiment of the present disclosure, a certificate used in a PKI certificate-based PnC service model of the prior art may be replaced with a concept of a proof. In a PKI-based PnC service authentication model of the prior art, three types of certificates are mandatorily used in a process of charging the EV 100 through the EVSE 200. Here, the mandatory certificate refers to a certificate required for a charging service between the EV and the EVSE, not a certificate used to establish a PKI certification system for stakeholders belonging to the EV charging ecosystem.

The three certificates may include an OEM provisioning certificate issued by the OEM server 210 and installed in the EV 100, an SECC certificate issued by the CSO 220 and installed in the EVSE 200, and a contract certificate issued by the EMSP 230 and installed in the EV 100. The three mandatory certificates may correspond to a vehicle certificate, a charger certificate, and a contract certificate, respectively, in the DID-based authentication model.

In general, the EV 100 may include an AVNT (i.e., abbreviation of Audio, Video, Navigation, and Telematics) module 160 for interfacing with the user, the EVCC 120 that communicates with the SECC, and an external communication control unit (e.g., telematics control unit (TCU))/communication module 130 capable of communicating with external Internet.

Inside the EV 100 as a DID-based authentication apparatus according to an embodiment of the present disclosure, a proof management module 110 such as an electronic wallet/identity wallet application, an encryption key management module 140 for generating/managing/providing an encryption key, and an encryption key storage module 150 for safe storage of an encryption key may be included.

As the proof management module 110, an electronic wallet for in-car payment services recently provided by the OEM may be used. Alternatively, a proof-dedicated identity wallet application for DIDs may be provided.

The verified encryption key management module 140 that can efficiently and safely manage encryption keys necessary for encryption/decryption and digital signature used in the EV's internal system, and the separate encryption key storage module 150 that can safely store the encryption keys may be included. As encryption key management/storage technologies of the encryption key management module 140 and the encryption key storage module 150, a known encryption key management system (KMS) may be used.

The encryption key storage module 140 may use a hardware security module (HSM) or a secure element (SE) of a hardware scheme or a whitebox cryptography (WBC) of a software scheme. In an embodiment of the present disclosure, if there is a problem in the confidentiality of the vehicle, even the safety of passengers may be threatened, so it may be recommended to mount a more secure hardware-based storage module.

The driver may communicate through the AVNT module 160 in the vehicle when the driver needs to request generation of a DID of the EV or issuance of various certificates or needs to identify information related to charging (S410). The AVN/AVNT module 160 may serve as an HMI through which the driver and the EV 100 communicate.

Communication between the EV 100 and the EVSE 200 may use a power line communication (PLC) communication scheme between the EVCC 120 and the SECC, which is also defined in the ISO 15118.

Communication between the EV 100 and the OEM server 210 may use a verified over-the-air (OTA) communication channel through wireless communication. Establishment of a secure communication channel with guaranteed confidentiality and integrity for OTA may be required.

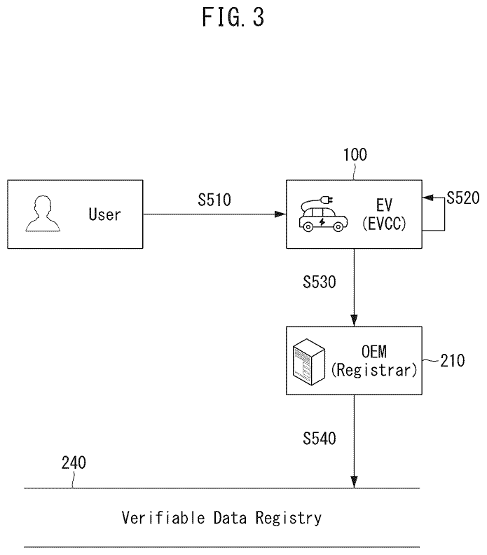

FIG. 3 is a conceptual diagram illustrating a process of generating a DID of an EV for a DID-based PnC authentication method according to an embodiment of the present disclosure.

The DID-based PC authentication method according to an embodiment of the present disclosure may further comprise a step S520 of generating, by the EV 100, a first DID in response to a first DID generation request from a user (S510). The method may further comprise a step S520 of generating, the EV 100, a first DID document corresponding to the first DID. The method may further comprise a step S530 of requesting, by the EV 100, registration of the first DID document to the OEM server 210. The method may further comprise a step S540 of transmitting, by the OEM server 210 and to the verifiable data registry 240, the first DID document to register the first DID document.

From the point of view of the EV user, the beginning of the DID-based authentication model is to generate and register a unique DID and a DID document capable of identifying the EV 100. In a general DID service model, when a user who is an information subject installs an application for managing certificates on a mobile device, an identity wallet where the certificates are stored and a unique DID that can identify the information subject may be generated. When generating the DID, a pair of public and private keys may also be generated by default. The step S520 of generating the DID by the EV 100 is not significantly different.

However, although the user may download and install an application, a method of installing an application provided by the OEM side is also possible. According to an embodiment of the present disclosure, it may be safe to receive an identity wallet application from the OEM.

In the step S510, the EV user may request generation of a DID through the AVNT module 160. In this case, a PIN code (4-digit or 6-digit number) required to generate an encryption key pair may also be input through the AVNT module 160.

In the step S520, a public key and a private key may be generated through the encryption key management module 140 in the internal system of the EV 100, and the private key may be safely stored in the encryption key storage module 150. The public key may be used to generate a DID and a DID document in accordance with World Wide Web Consortium (W3C)'s creation rules and may be included in the DID document capable of authenticating DID ownership.

In the step S530, when another object needs to register a DID document necessary to confirm DID ownership of the EV 100 in the distributed ledger, in consideration of safety and future scalability, a request of the registration may be made via the registrar constructed in the OEM server 210.

When the DID document is included in the distributed ledger through the OEM server 210 in the step S540, the process of generating the DID by the EV 100 may be completed.

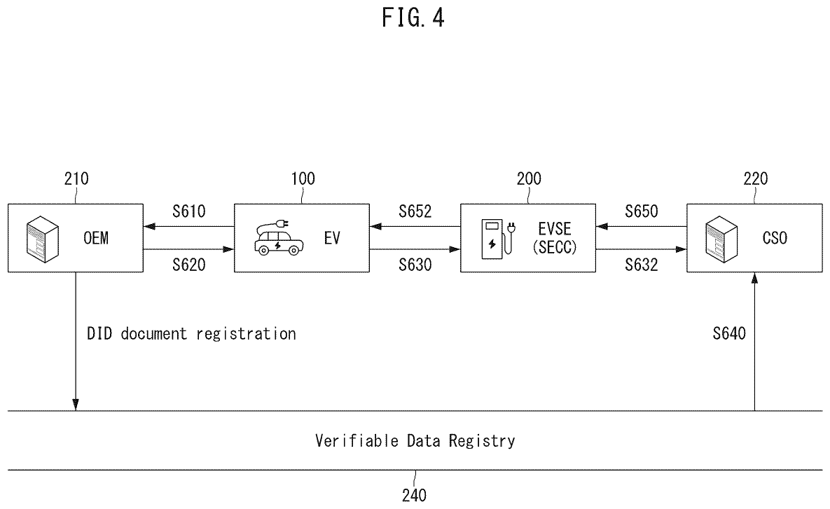

FIG. 4 is a conceptual diagram illustrating a process of issuing and submitting a vehicle certificate of an EV for a DID-based PnC authentication method according to an embodiment of the present disclosure.

The DID-based PnC authentication method according to an embodiment of the present disclosure may further comprise a step S610 of requesting, by the EV 100, the OEM server 210 to issue a vehicle proof and a step S620 of issuing and transmitting, by the OEM server 210 and to the EV 100, the vehicle proof. The method may further comprise a step S630 of submitting, by the EV 100, the vehicle proof to the EVSE 200 (S630) and a step S632 of requesting, by the EVSE 200, the CSO server 200 to verify the vehicle proof.

The vehicle proof is a proof serving the same role as the OEM provisioning certificate and issued by the OEM server 210 to the EV 100 as including information recorded in a PKI certificate profile. Unlike the PKI-based authentication model, the vehicle proof is not issued and installed at a production stage of the EV but may be installed inside the EV 100 when the EV user requests issuance through the AVNT module 160 for the first time after the EV 100 is sold.

The process, in which the EV 100 receives the vehicle proof and submits it for charging, and the vehicle proof is verified, may be similar to a structure of a DID service basic model composed of an issuer, a holder, and a verifier. However, since the EVSE 200 receiving the vehicle proof from the EV cannot verify the proof on its own, the EVSE 200 can request verification to the CSO server 220, i.e., the charging station operating system (S632).

FIG. 4 illustrates a process of verifying that the vehicle proof was issued by the OEM server 210 while submitting the vehicle proof when the EV 100 receives the vehicle proof, stores the received vehicle proof in the EV100, and is connected to the EVSE 200. In the step S610, the EV user may request issuance of the vehicle proof through the AVNT 160 inside the EV 100. In this case, a vehicle identification number (VIN), which is a unique number of the vehicle stored in advance in the AVNT 160, may be delivered to the OEM server 210, and the OEM server 210 may identify the vehicle.

In the step S620, the OEM server 210 may identify the EV corresponding to the VIN and issue the vehicle proof by including information for verifying the OEM together with the EV information in the vehicle proof. The EV 100 may safely store the vehicle proof in the proof management module (identity wallet) 110 inside. In the step S630, when the EV 100 is connected to the EVSE 200 for charging, the EV 100 may submit the vehicle proof to the EVSE 200 after going through a DID Auth process (S360) with the EVSE 200. The EVSE 200 may request verification of the DID to the charging station operating system 220 (S632).

In the S640, the charging station operating system 220 may verify issuer information registered in the distributed ledger based on the information included in the vehicle proof. In the steps S650 and S652, by verifying the issuer of the proof, the verification result of the vehicle proof may be delivered to the EV 100 via the EVSE 200, and thus the authentication result may be notified to the EV 100.

According to an embodiment of the present disclosure, an offline procedure in which the OEM informs the EV user of a Cert ID while selling the EV as in the PKI-based authentication mode may not necessarily be required.

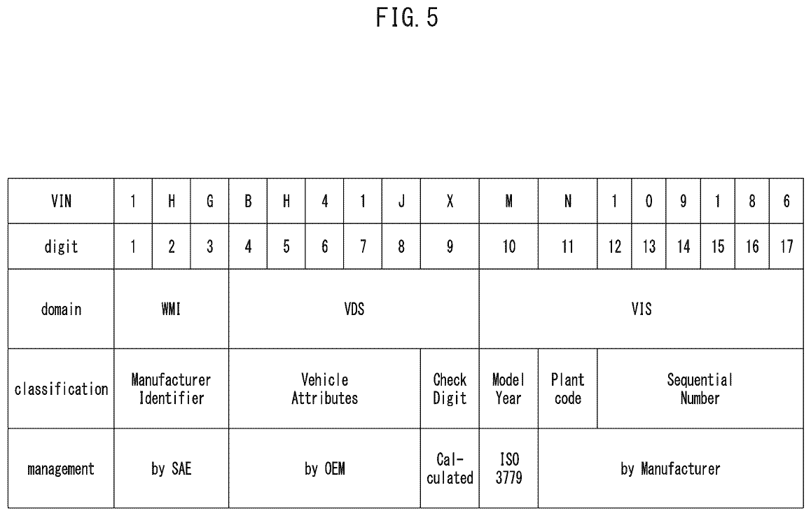

FIG. 5 is a conceptual diagram illustrating a format of a vehicle identification number (VIN), which is a unique identification number of a vehicle, for a DID-based PnC authentication method according to an embodiment of the present disclosure.

Information capable of identifying a PKI certificate is a Cert ID, and information capable of identifying a vehicle proof may be a VIN. The VIN is a unique number of the vehicle, which is assigned to the EV during a manufacturing process, may be a string consisting of 17 alpha-numeric characters. The VIN, which is usually called a chassis frame number, is used as an identifier of the vehicle for various cases such as insurance subscription and accident history inquiry and may be generated according to a predefined standard or rule as shown in FIG. 5.

FIG. 6 is a conceptual diagram illustrating a service subscription process and a contract proof issuance/storage process of an EV for a DID-based PnC authentication method according to an embodiment of the present disclosure.

The DID-based PnC authentication method according to an embodiment of the present disclosure may comprise a step S720 of transmitting, by the EV 100, a user's service subscription request to the OEM server 210. The method may also comprise a step S722 of transmitting, by the OEM server 210, the service subscription request to the EMSP server 230. The method may comprise a step S730 of generating, by the EMSP server 230, an EMAID and a step S742 of delivering the EMAID to the EV 100 via the OEM server 210 (S740) The method may also comprise a step S750 of requesting, by the user, issuance of a contract proof to the EV 100; a step S762 of delivering the vehicle proof from the EV 100 to the EMSP sever 230 via the OEM server 210 (S760). The method may also comprise a step S780 of issuing, by the EMSP server 230, the contract proof.

In an embodiment of the present disclosure, the contract proof may be a proof having the same role as the contract certificate in the PKI-based authentication model. In the PKI-based authentication model of the prior art, in order for the EV 100 to use a PnC service, the EV user needs to subscribe to a charging service of the EMSP server 230 in advance, receive the contract certificate, and install the received contract certificate in the EV.

Although the EV user subscribes to the charging service of the EMSP 230, the contract certificate is installed in the EV 100. As a method of subscribing to the service, subscription is usually made using a web page or mobile app provided by the EMSP server 230. When the user provides vehicle information or payment information using the web page or mobile app, the EMSP server 230 may issue the contract certificate and register the certificate and an encrypted private key in the CPS server.

Thereafter, when the EV 100 is connected to the EVSE 200 for the first time, the CPS server may deliver the contract certificate and the encrypted private key, and the contract certificate and the encrypted private key are installed in the EV.

In the DID-based authentication model according to an embodiment of the present disclosure, a time and a path of issuing a contract proof that plays the same role as the contract certificate of the prior art may be different from those for the contract certificate. As a method in which the EV user subscribes to a charging service and obtains a contract proof, when the EV user requests issuance of a contract proof through the AVNT 160 of the EV 100 (S750) and the request is delivered to the EMSP server 230 (S762) via the OEM server 210 (S760), the EMSP server 230 may issue the contract proof (S780) and deliver the contract proof to the EV 100 (S782, S790), similarly to the method of issuing the vehicle proof.

In the step S710, the EV user may select a service provider providing a charging service through the AVNT 160 of the EV 100 and input service subscription information. For service subscription, vehicle information, payment information, and a PIN code required for user identification may be required.

Information input to the AVNT 160 of the EV 100 in the steps S720 and S722 may be delivered to the EMSP server 230 through a backend system of the OEM server 210. Here, the OEM server 210 may serve as a kind of API gateway.

In the step S730, the EMSP server 230 may review subscription information of the EV user and request the user if identity verification for payment information is required. When subscription is approved, an EMAID may be generated.

In the steps S740 and S742, the EMSP server 230 may deliver a subscription approval result together with the EMAID to the EV 100.

If subscribing to the charging service is successful, the EV user may request issuance of a contract proof through the AVNT 160 in the step S750. In the steps S760 and S762, the EV 100 may submit the vehicle proof to the EMSP server 230 via the OEM server 210 to request issuance of the contract proof.

In the step S770, the EMSP server 230 may verify issuer information registered in the distributed ledger based on the information included in the vehicle proof.

When normally verified in the step S770, the EMSP server 230 may issue the contract proof in the step S780. The contract proof issued in the steps S782 and S790 may be delivered to the EV 100 and safely stored in the proof management module (identity wallet) 110.

Here, the user identification information is used as an account of the EV user, and the 17-digit VIN, which is the identification number of the vehicle, and a PIN code directly input by the user may be cryptographically combined. The VIN is a unique identification number composed of vehicle manufacturer information (i.e., world manufacturer identifier (WMI)), vehicle characteristic information (e.g., vehicle descriptor section (VDS)), and a production serial number (e.g., vehicle indicator section (VIS)) assigned by the manufacturer according to a predefined rule. Even when the user is changed, the VIN may not be changed unlike a license plate of the vehicle. Therefore, in order to be used as a user ID, it is required to be configured so that the user ID can be changed in combination with the information input by the EV user.

A function to change or delete the vehicle proof or contract proof may be required for a case when the EV owner is changed or the EV user withdraws from the charging service contract.

According to an embodiment of the present disclosure, without being limited to the case where a contract proof is issued when the EV 100 is first connected to the EVSE 200, after the EV user purchases the EV 100, the EV user may request issuance of a contract proof while subscribing to a charging service without going to an EV charging station 200. Of course, various options may be provided for convenience, such as a scheme in which the EV user subscribes to a service through a web page or mobile app and performs request of issuance of a contract proof through the AVNT 160 of the EV 100.

In the PKI-based authentication model of the prior art, to which the ISO 15118 is applied, it is specified that a certificate is injected during the production process of the EV or installed when the EV is first connected to a charger. On the other hand, in embodiments of the present disclosure, issuance of a proof may be requested through the AVNT 160 installed inside the EV 100, and the proof may be issued by communicating with the OEM backend server 210 in a wireless OTA environment. According to exemplary embodiments of the present disclosure, the cost and effort of injecting a certificate in the production process of the EV 100 can be reduced, and even if reissuance is required, the certificate can be easily reissued. The simplicity of proof issuance and installation may be expanded to various services by which the EV user can use the EV.

In an embodiment of the present disclosure, the EV user may use the AVNT 160, also known as an infotainment system, as an interface device to communicate with the EV 100 connected to communication outside the vehicle.

The EV 100 may deliver the EV user's request to the OEM server 210 or the EMSP server 230 via the AVNT 160 and output a result therefor.

The AVNT 160 is a component device manufactured or assembled by the OEM, and software functions are required to be supported by the AVNT 160 in order to implement the DID-based authentication model. As map information of a navigator provided by the AVNT 160 is updated, if data is added or functions are changed in the AVNT program for the DID-based authentication model for EV charging, it may be upgraded by the OEM server 210 through OTA.

Since the AVNT 160 plays the same role as a mobile device in the DID-based basic service model in which a person is an information subject, basic security functions such as screen locking or authentication of the EV user may be required to be added to prevent other persons than the EV user from seeing important information.

The AVNT 160 provides a DID management function and may provide ‘DID generation’/‘DID deletion’ as a display menu. Specifically, a function of generating and deleting a DID of a vehicle together with generation of a pair of private and public keys may be related thereto.

The AVNT 160 provides a vehicle proof management function and may provide ‘vehicle proof issuance’/‘vehicle proof reissuance’/‘vehicle proof confirmation’ as a display menu. Specifically, a function of issuing and reissuing (deleting and then issuing) a vehicle proof, and a function of checking contents and status of a vehicle proof may be related thereto.

The AVNT 160 may provide a service subscription function and may provide ‘charging service subscription’/‘charging service withdrawal’ as a display menu. Specifically, functions such as a function to pre-register for a charging service provided by the EMSP server 230, a search function when there are multiple EMSPs, and a roaming function for using other charging services within one service contract (i.e., full roaming condition) may be related thereto.

The AVNT 160 may provide a contract proof management function. As a display menu, ‘contract proof issuance’/‘contract proof reissuance’/‘contract proof deletion’/‘contract proof confirmation’ may be provided. Specifically, functions such as a function of issuing or reissuing a contract proof after service subscription, a function of deleting a contract proof, and a function of checking contents and status of a contract proof may be related thereto.

The AVNT 160 may provide a user input function. As a display menu, ‘PIN code input’ and the like may be provided. Specifically, functions such as a PIN code input function for generating a private key, a PIN code input function for generating a service ID, and the like may be related thereto.

The AVNT 160 may provide an information inquiry function. As a display menu, ‘VIN inquiry’/‘EMAID inquiry’/‘charging service ID inquiry’ and the like may be provided. Specifically, functions such as a function of inquiring a vehicle unique identification number (currently available on a dashboard or under a driver's or passenger's seat), a function of inquiring an EMAID for charging a charging contract fee, and a function of identifying all or part of a charging service ID that is a cryptographic combination of the VIN and PIN code may be related thereto.

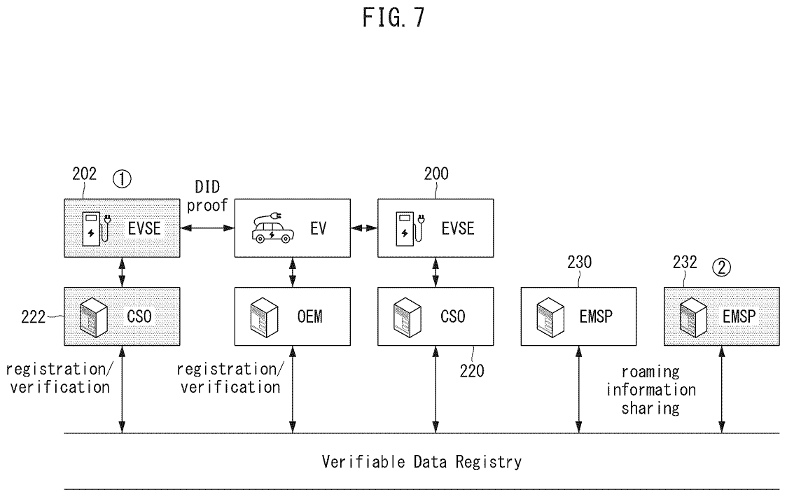

FIG. 7 is a conceptual diagram illustrating a use case scenario that provides scalability according to an increase in participants in a DID-based PnC authentication process according to an embodiment of the present disclosure.

In the prior art PKI-based authentication model, interoperability becomes complicated due to various certificates as the number of participants increases. However, according to embodiments of the present disclosure, scalability and interoperability may be provided by sharing a trust-based distributed ledger. For a PnC service, there are basically various participants such as a V2G Root CA operator, OEM, EMSP, CSO, and the like. As the sales of EVs increase and the charging infrastructure to support them expands, PnC services are being developed and attracting attention. It is a paradoxical situation that many participants should appear in order to solve the above-mentioned problem of independence of higher certification authorities, but the complexity of the PKI certification system to be built increases as the number of participants increases.

As shown in FIG. 7, even when a new CSO server 222 is added as a participant in the embodiments of the present disclosure, the new CSO server 222 may be connected to a reliable distributed ledger without worrying about connection to a higher certification authority or PKI authentication system and may easily participate in the authentication system of the present disclosure if it complies with the DID generation and certificate issuance/verification protocol.

Even when a new EMSP server 232 is added in FIG. 7, it may be connected to the distributed ledger, so that it can see the same ledger in common and easily share necessary roaming information.

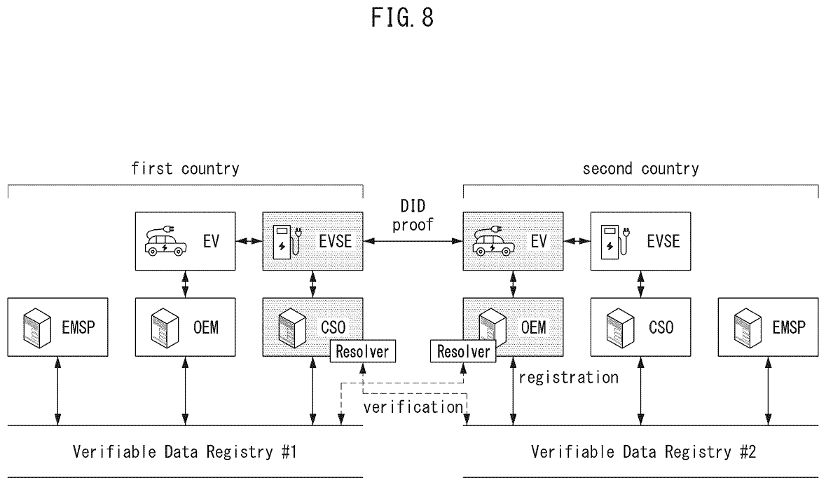

FIG. 8 is a conceptual diagram illustrating a use case scenario in which connectivity between different regions/countries/continents is provided in a DID-based PnC authentication process according to an embodiment of the present disclosure.

The DID-based PnC authentication method according to an embodiment of the present disclosure may further comprise a step of receiving, by the EV 100, power from a second EVSE 200 adjacent to the EV, which is an EVSE other than the EVSE 202 with which the EV 100 has mutually authenticated the first DID and the second DID.

The DID-based PnC authentication method according to an embodiment of the present disclosure may further comprise a step of receiving, by the second EVSE 200, a result of the mutual authentication of the first DID and the second DID from the EVSE 202.

In other words, according to an embodiment of the present disclosure, an EVSE other than an EVSE from which the EV 100 is to receive power may participate in an authentication process using the DID of the EV 100. In this case, the DIDs required for the mutual authentication process may be the DIDs of the EV 100 and the EVSE to supply power and, depending on embodiments, the DID of the EVSE participating in the authentication process also needs to be verified in the mutual authentication process.

Although not shown in FIG. 8, the DID-based PnC authentication method according to an embodiment of the present disclosure may further comprise: a step of transmitting the first DID possessed by the EV 100 to an entity belonging to an intelligent transportation system (ITS); a step of receiving, by the EV 100, a third DID from the entity: and a step of mutually authenticating, by the EV and the entity, the first DID and the third DID.

In other words, referring to FIG. 8 and an extensible embodiment, when using the DID-based PnC authentication method according to an embodiment of the present disclosure, DIDs distributed over a vertical structure of participants participating in a business model for supplying electric power to the EV 100 may be used, and the EV 100 may mutually exchange the DID with different charging infrastructures or infrastructures/entities installed on the road, thereby improving security.

In addition, by adding infrastructure and entities participating in authentication, the DID of the EV 100 may be cross-checked. Accordingly, it is possible to more effectively block a fraudulent act in which a malicious user uses power without a charging fee and a fraudulent act in which a malicious user's charging fee is imposed on a normal EV user.

Expanding the application range, embodiments of the present disclosure may be applied to a PnC service provider group including a plurality of participants or PnC service provider groups linked between countries/continents. As the more participants, the greater the interoperability. However, there must also be a prerequisite that the DID-based authentication model is widely distributed and activated in the EV charging ecosystem. In addition, active participation of various alliances for DIDs is also required.

Embodiments of the present disclosure may eliminate an issue of independence of trust anchors among the problems of the PnC service of the prior art.

In the prior art, there are several methods for constructing a PKI authentication system by applying the ISO 15118. In order to strengthen the reliability of certificates, a Root CA, the top-level trust authority that manages certificate authorities (CAs) exists, but the reliability problem of the Root CA remains in the end. Although the most neutral institution should perform the role of V2G Root CA, the problem of how to secure reliability between V2G Root CAs placed by continents still exists. Although a lot of time has passed since the development of the ISO 15118 standard began, the issue of independence of the Root CA is also related to the continued attempts by the SAE international to design and test a safe, reliable, and scalable EV charging PKI platform.

In the embodiment of the present disclosure, unlike the prior art, this reliability problem may be solved by applying a distributed ledger technology in which a separate higher trust authority does not exist, and blocks generated by a consensus algorithm are connected to ensure integrity. In addition, the problem of reliability between regions or continents may be solved by linking DID-based authentication models thereof.

In the PKI-based authentication model of the prior art, a key pair is generated in a back-end server of the OEM or parts manufacturer during the production process, a public key is delivered through the OEM PKI system, a certificate is issued, and the certificate is injected into the EV. In this case, there are two security problems. First, a private key is delivered through a production chain network. It is recommended that the private key is generated in a device that will own the key and stored and managed safely without transmission over a network. Second, a security management of the back-end server of the OEM or parts manufacturer (i.e., tier 1) may be weak. In the process of issuing a public key/private key pair, one more weak point arises.

In an embodiment of the present disclosure, in order to solve the above-described problem, the EV user may directly generate an encryption key pair inside the vehicle through the AVNT after taking over the vehicle. The public key is included in the DID document and registered in the distributed ledger through the OEM, but the private key is safely stored in the encryption key management module of the vehicle's internal system at the same time it is generated. It does not go through an intermediate server, so security can be increased.

According to the ISO 15118 of the prior art, since a TLS authentication of the PKI-based authentication model is unidirectional, when the EV 100 is connected to the EVSE, only a certificate of the EVSE is verified and a certificate of the EV is not verified.

In an embodiment of the present disclosure, when the EV 100 is connected to the EVSE, mutual identification is performed through the DID Auth process, and then each proof is exchanged to undergo the mutual authentication process. In a trend where cyber-attack techniques are becoming more advanced and intelligent, mutual authentication between the EV and the EVSE is essential to enhance security.

In the PKI-based authentication model of the prior art, a validity period of the OEM provisioning certificate is usually set to more than 20 years in consideration of a service life of the vehicle. However, within the PKI authentication system, there may occur a case in which a leakage of the key due to a security accident occurs or a case in which a part containing the certificate is replaced due to a vehicle damage caused by a physical traffic accident. In this case, due to the absence of the OEM provisioning certificate in the EV, costs and efforts for reissuing and installing the OEM provisioning certificate may be incurred, and security vulnerability may occur during the absence of the OEM provisioning certificate. In this case, it is possible to prepare for a larger security incident by performing a reissuance procedure after revoking the certificate in each vehicle as quickly as possible. The OTA service may become a very effective tool for this case. In the opposite case, the validity period of the certificate is too long, which may cause problems. The validity period of the V2G root certificate installed together with the OEM provisioning certificate in the EV should be longer than the validity period of the OEM provisioning certificate. Otherwise, all certificates in the vehicle may need to be replaced due to expiration of the validity period of the V2G root certificate. However, the validity period cannot be determined indefinitely, and there is a burden of replacing the V2G root certificate when the validity period, which is much longer than 20 years, expires. The replacement work done on a regular basis is unlikely to cause a problem, but the replacement work done once every few decades may also cause a failure.

In the embodiment of the present disclosure, service availability can be ensured because the DIDs and the DID documents can be easily replaced and the proof can be reissued without the burden of replacing the certificate.

The ISO 15118 of the prior art stipulates that an OEM provisioning certificate should be prepared as OEM requirements. There are two ways to install the OEM provisioning certificate in the EV. In order to issue the OEM provisioning certificate, a process of generating a pair of a public key and a private key for a issuance target may be started. This may depend on where the key pair is generated. Considering that the OEM provisioning certificate is mounted on a specific ECU, it is actually difficult to install the OEM provisioning certificate when assembling parts in a finished vehicle factory, and it is relatively easy to install the OEM provisioning certificate by an ECU manufacturer. However, it is not easy even for the ECU manufacturer to inject the certificate and the private key into an ECU without a failure on a factory line that operates non-stop in real time.

In the DID-based authentication model according to an embodiment of the present disclosure, the method for issuing a vehicle proof by the owner through the AVNT after the EV is sold, not during the production process, is proposed. The process of pre-installing a V2G root CA certificate in the EV in the PKI-based authentication model of the prior art is not required in the embodiments of the present disclosure. In addition, proposed is the procedure for conveniently issuing a contract proof through the AVNT within the EV, which plays the same role as a contract certificate installed when the EV 100 is first connected to the EVSE after service subscription to a charging service is made in advance. In addition, when the EV owner changes, it is also possible to conveniently delete the contract proof. The function of conveniently deleting and installing the proof enables embodiments of the present disclosure to be utilized in various services. Even when renting an EV, the PnC service can be used without using an external identification means (EIM). In the process of subscribing to a rental service, there are cases where it is uneasy to provide payment information. However, according to embodiments of the present disclosure, it is made possible to enter the payment information directly through the AVNT inside the EV and delete it after completing the EV rental service.

The embodiments of the present disclosure are based on a scheme of verifying the DID through the distributed ledger, but the PKI-based authentication model of the prior art is based on a scheme of verifying the PKI certificate through a CA and an OCSP.

In the prior art, since verification is performed only through the centralized CA and registration authority (RA), a verification time delay may occur due to traffic at this time. In the embodiments of the present disclosure, since the decentralized distributed ledger is used, it is not necessary to concentrate verification requests on a specific central server, and verification can be performed optimized in a given environment, and thus the verification time can be reduced.

Using the embodiments of the present disclosure, it is possible to reduce the cost of establishing the authentication system for issuing the PKI certificate. A unified vehicle-to-grid (V2G) certification system, which is the most ideal type of PKI certification system as the conventional technology suggested by the ISO 15118, has a form of integrating higher root CAs of secondary actors such as OEM, EMSP, and CSO into one. However, in this structure, subordinate CAs should eventually be built on the secondary actor side, and an OCSP for certificate verification or registration authorities (RAs), an agency registration authority, should also be constructed when necessary. The cost of establishing the authentication system for each service provider and the cost of creating a roaming system for linking services are not insignificant.

In contrast, in the embodiments of the present disclosure, it is possible to use public distributed ledgers that have already been built variously, and the embodiments of the present disclosure have the advantage of reducing costs by using consortium distributed ledgers provided by several DID-related alliances.

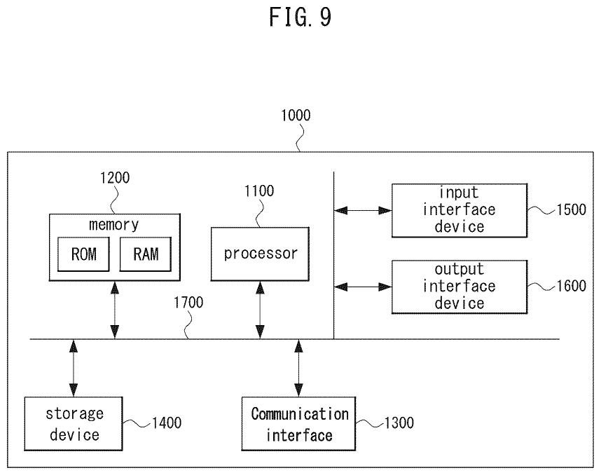

FIG. 9 is a conceptual diagram illustrating an example of a generalized DID-based PnC authentication apparatus, a controller of an EV, or a computing system capable of performing at least part of the processes of FIGS. 1-8.

At least some processes of the DID-based PnC authentication method according to embodiments of the present disclosure may be executed by a computing system 1000 of FIG. 9.

As shown in FIG. 9, the computing system 1000 according to an embodiment of the present disclosure may be configured to include a processor 1100, a memory 1200, a communication interface 1300, a storage device 1400, an input interface 1500, an output interface 1600, and a bus 1700.

The computing system 1000 according to an embodiment of the present disclosure may include the at least one processor 1100 and the memory 1200 storing instructions instructing the at least one processor 1100 to perform at least one step. At least some steps of the method according to embodiments of the present disclosure may be performed by the at least one processor 1100 loading the instructions from the memory 1200 and executing them.

The processor 1100 may mean a central processing unit (CPU), a graphics processing unit (GPU), or a dedicated processor on which the methods according to embodiments of the present disclosure are performed.

Each of the memory 1200 and the storage device 1400 may include at least one of a volatile storage medium or a non-volatile storage medium. For example, the memory 1200 may include at least one of a read only memory (ROM) or a random access memory (RAM).

In addition, the computing system 1000 may include the communication interface 1300 that performs communication through a wireless network.

In addition, the respective components included in the computing system 1000 may be connected by the bus 1700 to communicate with each other.

For example, the computing system 1000 of the present disclosure may be a desktop computer, a laptop computer, a notebook, a smart phone, a tablet PC, a mobile phone, a smart watch, a smart glass, e-book reader, a portable multimedia player (PMP), a portable gaming device, a navigation device, a digital camera, a digital multimedia broadcasting (DMB) player, a digital audio recorder, a digital audio player, a digital video recorder, a digital video player, a personal digital assistant (PDA), and the like having communication capability.

The DID-based PnC authentication apparatus according to an embodiment of the present disclosure may include the memory 1200 for storing at least one instruction and may include the processor 1100 that executes the at least one instruction. The processor 1100 may execute the at least one instruction to: execute an electronic wallet application that stores and manages DIDs: transmit a first DID stored in the electronic wallet application to the EVSE 200; receive a second DID possessed by the EVSE 200; receive a second DID document for verification of the second DID: and mutually-authenticate the first DID and the second DID with the EVSE 200.

The memory 1200 and processor 1100 may be mounted on the EV 100, and the DID-based PnC authentication apparatus may be a controller installed in the EV 100.

The processor 1100 may execute the at least one instruction to: request verification of the second DID to the OEM server 210 and receive the second DID document from the OEM server 210.

The processor 1100 may execute the at least one instruction to, when the mutual authentication with the EVSE 200 for the first DID and the second DID is completed, control the EV 100 to receive electric power from the EVSE 200.

Referring to FIGS. 7 and 9 together, the processor 1100 may execute the at least one instruction to, when the mutual authentication with the EVSE 202 for the first DID and the second DID is completed, control the EV 100 to receive electric power from a second EVSE 200 adjacent to the EV 100, which is an EVSE other than the EVSE 202.

The processor 1100 may execute the at least one instruction to: generate the DID by controlling the electronic wallet application in response to a user's request for generating the first DID: generate the first DID document corresponding to the first DID by controlling the electronic wallet application: and request the OEM server 210 to register the first DID document.

The operations of the method according to the embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus, which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some embodiments, a programmable logic device such as a field-programmable gate array may be used to perform some or all of functions of the methods described herein. In some embodiments, the field-programmable gate array may be operated with a microprocessor to perform one of the methods described herein. In general, the methods are preferably performed by a certain hardware device.

The description of the disclosure is merely exemplary in nature and thus variations that do not depart from the substance of the disclosure are intended to be within the scope of the disclosure. Such variations are not to be regarded as a departure from the spirit and scope of the disclosure. Thus, it should be understood by those of ordinary skill in the art that various changes in form and details may be made without departing from the spirit and scope of the present disclosure.

What is claimed is:

1. A decentralized identity (DID)-based Plug and Charge (PnC) authentication method comprising:
transmitting, by an electric vehicle (EV), a first DID possessed by the EV to an electric vehicle supply equipment (EVSE);
transmitting, by the EVSE, a second DID possessed by the EVSE to the EV;
receiving, by the EV, a second DID document required for verification of the second DID;
receiving, by the EVSE, a first DID document required for verification of the first DID; and
mutually-authenticating, by the EV and the EVSE, the first DID and the second DID with each other.

2. The DID-based PnC authentication method according to claim 1, further comprising: requesting, by the EV, verification of the second DID to an original equipment manufacturer (OEM) server, wherein in the receiving of the second DID document, the EV receives the second DID document from the OEM server.

3. The DID-based PnC authentication method according to claim 2, further comprising: receiving, by the OEM server, the second DID document from a verifiable data registry.

4. The DID-based PnC authentication method according to claim 3, further comprising: transmitting, by a resolver module of the OEM server, a search request for the second DID document stored in the verifiable data registry to the verifiable data registry.

5. The DID-based PnC authentication method according to claim 1, further comprising: requesting, by the EVSE, verification of the first DID to a charging station operator (CSO) server, wherein in the receiving of the first DID document, the EVSE receives the first DID document from the CSO server.

6. The DID-based PnC authentication method according to claim 5, further comprising: receiving, by the CSO server, the first DID document from a verifiable data registry.

7. The DID-based PnC authentication method according to claim 1, wherein the mutually-authenticating comprises:
authenticating, by the EV, the verified second DID; and
authenticating, by the EVSE, the verified first DID.

8. The DID-based PnC authentication method according to claim 1, further comprising: receiving, by the EV, electric power from the EVSE.

9. The DID-based PnC authentication method according to claim 1, further comprising: receiving, by the EV, electric power from a second EVSE adjacent to the EV, the second EVSE being an EVSE other than the EVSE that has mutually authenticated the first DID and the second DID.

10. The DID-based PnC authentication method according to claim 9, further comprising: receiving, by the second EVSE, a result of mutually authenticating the first DID and the second DID from the EVSE.

11. The DID-based PnC authentication method according to claim 1, further comprising:
transmitting, by the EV, the first DID possessed by the EV to an entity belonging to an intelligent transportation system;
receiving, by the EV, a third DID from the entity; and
mutually-authenticating, by the EV and the entity, the first DID and the third DID with each other.

12. The DID-based PnC authentication method according to claim 1, further comprising:
generating, by the EV, the first DID in response to a first DID generation request of a user;
generating, by the EV, the first DID document corresponding to the first DID;
requesting, by the EV, an OEM server to register the first DID document; and
transmitting, by the OEM server, the first DID document to a verifiable data registry for registration.

13. The DID-based PnC authentication method according to claim 1, further comprising:
requesting, by the EV, an OEM server to issue a vehicle proof;
issuing and transmitting, by the OEM server, the vehicle proof to the EV;
submitting, by the EV, the vehicle proof to the EVSE; and
requesting, by the EVSE, a CSO server to verify the vehicle proof.

14. The DID-based PnC authentication method according to claim 1, further comprising:
transmitting, by the EV, a service subscription request of a user to an OEM server;
transmitting, by the OEM server, the service subscription request to an e-mobility service provider (EMSP) server;
generating, by the EMSP server, an e-mobility account identifier (EMAID);
transmitting, by the EMSP server, the EMAID to the EV via the OEM server;
requesting, by the user, issuance of a contract proof to the EV;
transmitting, by the EV, a vehicle proof to the EMSP server via the OEM server in response to the request for issuance of the contract proof; and
issuing, by the EMSP server, the contract proof.

15. A decentralized identity (DID)-based Plug and Charge (PnC) authentication apparatus comprising:
a memory configured to store at least one instruction; and
a processor configured to execute the at least one instruction,
wherein the processor executes the at least one instruction to
execute an electronic wallet application that stores and manages DIDs;
transmit a first DID stored in the electronic wallet application to an electric vehicle supply equipment (EVSE);
receive a second DID possessed by the EVSE;
receive a second DID document required for verification of the second DID; and
mutually-authenticate the first DID and the second DID with the EVSE.

16. The DID-based PnC authentication apparatus according to claim 15, wherein the processor and the memory are mounted on an electric vehicle (EV).

17. The DID-based PnC authentication apparatus according to claim 15, wherein the processor executes the at least one instruction to:
request an original equipment manufacturer (OEM) server to verify the second DID; and
receive the second DID document from the OEM server.

18. The DID-based PnC authentication apparatus according to claim 15, wherein the processor executes the at least one instruction to: when a mutually-authenticating with the EVSE for the first DID and the second DID is completed, control the EV to receive electric power from the EVSE.

19. The DID-based PnC authentication apparatus according to claim 15, wherein the processor executes the at least one instruction to: when a mutually-authenticating with the EVSE for the first DID and the second DID is completed, control the EV to receive electric power from a second EVSE adjacent to the EV,
wherein the second EVSE is an EVSE other than the EVSE that has mutually authenticated the first DID and the second DID.

20. The DID-based PnC authentication apparatus according to claim 15, wherein the processor executes the at least one instruction to:
control the electronic wallet application to generate the first DID in response to a first DID generation request of a user;
control the electronic wallet application to generate a first DID document corresponding to the first DID; and
request the OEM sever to register the first DID document.
